(19) United States
(12) Patent Application Publication
(10) Pub. No.: US 2009/0030710 A1
(43) Pub. Date: Jan. 29, 2009

(54) CENTRALIZED DISPUTE RESOLUTION SYSTEM FOR COMMERCIAL TRANSACTIONS

(75) Inventor: Michael Levine, Corte Madera, CA (US)

Correspondence Address: TOWNSEND AND TOWNSEND CREW LLP, TWO EMBARCADERO CENTER, 8TH FLOOR, SAN FRANCISCO, CA, 94111, US

(73) Assignee: Visa U.S.A. Inc., San Francisco, CA (US)

(21) Appl. No.: 11/829,277

(22) Filed: Jul. 27, 2007

(51) Int. Cl. G06Q 10/00; G06F 17/30

(52) U.S. Cl. 705/1

(57) ABSTRACT

A centralized dispute resolution system for use in commercial credit or debit card transactions. The inventive system utilizes a common data storage, interfaces, processes, procedures, rules, and other elements of a dispute resolution system that are made available to cardholders, merchants, card issuers, payment processors, and other parties that may be involved in a dispute or in a process intended to resolve a dispute. The system may be implemented using a client-server architecture with communication between clients and one or more server elements provided by a communications network.

### BACKGROUND

The present invention is directed to systems, apparatus and methods for managing the resolution of disputes that arise in commercial transactions, and more specifically, to a centralized system for the management of data and processes involved in the resolution of disputes that arise from credit and debit card type transactions.

Credit and debit cards are used today by millions of people on a regular basis for commerce and banking transactions. In a typical credit or debit card transaction, a card issuer such as a bank, credit union or commercial organization issues a card or other form of payment mechanism to a cardholder (e.g., customer) to use in commerce transactions. The cardholder presents the card or payment mechanism to a merchant (typically at a point of sale or via a communications network for a remote transaction) to initiate a transaction, such as a purchase of goods or services. The card issuer manages the cardholder account and arranges with a payment processor or payment processor network to execute the processes involved in completing transactions requested by a cardholder. These transaction processes typically include verifying the account status and identity of the cardholder and/or merchant, approving the transaction, collecting the data required to complete the record of the transaction, and facilitating the settlement process. In the case of a credit card based transaction this would include charging the amount of the goods or service against the credit limit of the cardholder, while in a debit card based transaction this would include charging the amount of the goods or service against the balance of the cardholder's banking account.

Another entity typically involved in such transactions is the acquirer, or merchant's bank. In a typical transaction, the acquirer forwards the transaction request received from the merchant to an intermediary organization such as Visa™ or MasterCard™, who then provides the request and associated transaction related data to the card (payment mechanism) issuer. The transaction request is then processed by the card issuer or payment processor and if authorized, an authorization message is sent to the acquirer and merchant, thereby enabling completion of the transaction. The payment mechanism issuer, acquirer, and payment processor may belong to a network of such entities, such as Visa™ or MasterCard™.

Although the majority of such transactions occur without any complications, in some cases either the cardholder or merchant becomes dissatisfied with some aspect of the transaction. Typical reasons for such dissatisfaction include the failure or perceived failure to deliver goods or services as promised, or an unresolved complaint regarding the goods, services or payment for the goods or services. Another potential source of dissatisfaction is an assertion that some aspect of the transaction is fraudulent, such as when a cardholder challenges an item on their credit card bill. When such examples of dissatisfaction occur, they may lead to the initiation of a dispute between the cardholder and merchant or between another entity involved in the transaction process and the cardholder or merchant.

Presently, when such disputes are initiated they are managed through a dispute resolution (DR) system, which may be part of a customer relations function. The DR system may be partially or fully automated and is typically responsible for managing the dispute resolution process, including collecting the required data, communicating with the parties involved, and conducting the dispute resolution process in accordance with the relevant codes, regulations, and rules.

Typically, each card (payment mechanism) issuing entity and/or payment processor (or network of such participants to a transaction) has a separate DR system and set of rules, conditions, regulations, and processes for conducting a dispute resolution activity. There may also be a separate DR system and set of rules and procedures for each issuing party network, such as Visa™ or MasterCard™. Further, there may be differences in the DR system or procedures followed depending upon whether the transaction was initiated using a credit card, debit card, or other form of payment mechanism. In addition to having separate and possibly different rules, procedures, and regulations, each DR system may be accessed using a different customer care system, user interface, or other system elements. In general, each such DR system is a closed, proprietary system that does not exchange data and is not required to have common procedures with DR systems operated by parties falling outside of a specific group, affiliation or network.

Although presently used DR systems provide a desirable service for customers (e.g., cardholders and merchants), the ways in which such systems are implemented do have disadvantages. For example, if a card issuing entity is responsible for issuing more than one type of payment mechanism (e.g., both Visa™ and MasterCard™), then that entity must interact with more than one DR system, each with its own set of rules and processes. This creates an administrative problem by increasing overhead and employee training requirements. In addition, it requires existing data processing and computing systems to be able to connect to and interface with the multiple DR systems, resulting in increased information systems (IS) management overhead. This may introduce additional complexity, costs and inefficiencies, not to mention potential sources of customer dissatisfaction.

Similarly, a cardholder or merchant must utilize the DR system corresponding to the payment processor or issuing entity that is appropriate for the transaction in question. This requires the cardholder or merchant to learn the processes and rules for multiple DR systems and follow those applicable to the transaction in question. This can be a source of customer dissatisfaction and in extreme cases, may create a disincentive on the cardholder's or merchant's part to utilize the payment mechanism involved. Further, because some DR systems may have procedures, terms, or conditions that are considered by users to be preferable to or more favorable than those of other DR systems, potential users may have incentives to over or under utilize such systems. This in effect makes the DR system a factor in a user's decision whether or not to utilize a particular payment mechanism, etc., which is a potentially undesirable consequence of the lack of standardized procedures, etc.

Thus, with multiple, separate DR systems in place, issuers, cardholders, and merchants are subject to multiple sets of proprietary and/or specialized dispute resolution rules and processes. This requires each party involved in a dispute to learn and use multiple methods and systems for dispute resolution, instead of having a unified, standardized method and set of rules for the management and execution of a dispute resolution process.

Another disadvantage of presently implemented DR systems is that because they are separate and proprietary systems, the overall DR process lacks a central depository or means of accessing transaction and DR data. This is detrimental to the operation of the commercial transaction system because it prevents or at least frustrates certain desirable activities. These desirable activities include tracking fraudulent cardholder claims, incidences of poor service by a merchant or DR system in responding to claims, and “excessive” dispute activities or claims by a cardholder or merchant across multiple payment processing systems or transaction related networks. In general, the lack of a central data depository or commonly accessible DR and transaction records may have negative impacts because of an inability to have a broad overview of the dispute resolution environment and activities.

Further, the lack of a centralized DR system and administrating entity may also limit the ability to bar fraudulent cardholders or merchants from continued use of other payment processing and DR systems, since there is limited data on patterns of fraud spread across multiple card issuers and no enforcement ability across or into other payment processing networks. In addition, if the acquirer and card issuer do not belong to a common payment processing network, they may be unable to access some of the data regarding a dispute, thereby reducing the ability of the DR system to assist in resolving the dispute.

What is desired is a dispute resolution system for use in commercial transactions that overcomes the noted disadvantages of the current approach.

### BRIEF SUMMARY

The present invention is directed to a centralized dispute resolution system suitable for use in disputes that arise from commercial credit or debit card transactions. The inventive system utilizes common data storage, interfaces, processes, procedures, rules, and other elements of a dispute resolution system. The common elements are made available to cardholders, merchants, card issuers, payment processors, and other parties that may be involved in a dispute or in a process intended to resolve a dispute. The system may be implemented using a client-server architecture with communication between clients and one or more server elements provided by a communications network, such as the Internet.

The inventive system utilizes a common data store and set of user interfaces and processes for dispute initiation, tracking, resolution, and adjudication of disputes, as well as standardized processes for communicating between the parties involved in a dispute. The standardized elements, processes, and other aspects of the inventive system are common across multiple payment networks, card issuers, and other parties potentially involved in a dispute.

By providing a standardized and commonly accessible set of interfaces, data stores, methods, rules, processes, etc. for the parties involved in a dispute, the inventive system reduces administrative overhead and system complexity, while providing advantages for the parties involved. These advantages include, but are not limited to, reduced user training time (since once the interfaces, processes and rules are used for a first time, there is very little additional learning required for subsequent uses), and an overall improvement in the user experience with the dispute resolution system. The use of standardized event codes, rules, regulations, and processes enables parties using the system to interact in a predictable and better understood manner with the other entities involved in the dispute resolution process. This is at least partly because without a commonly accessible and standardized system, the parties would be forced to interact within a proprietary environment that required its own training and administrative support. Such a situation would also increase the possibility of confusion or miscommunication when attempting to compare activities occurring within different proprietary DR systems. The use of a common system also serves to reduce incentives for “forum shopping” among cardholders or merchants who might otherwise select a payment mechanism or otherwise require a transaction to involve a network or group that provided them with the most favorable DR practices.

In addition to overcoming certain disadvantages of the existing set multiple of DR systems, the inventive system provides advantages not possible with a group of closed and proprietary DR systems. These advantages include a centralized or distributed common data storage system accessible by all parties involved, and the resulting ability to process the stored data to track fraud across previously separated DR systems and networks. This may provide the ability to detect fraud patterns sooner, or to detect fraud events that might otherwise have gone undetected. The common data store and system processes also provide an improved ability to regulate users of the credit or debit card services, such as by enforcing penalties by depriving access to the entire payment processing system in the event of a detected pattern of fraud by either a cardholder or merchant. The system also benefits the parties involved in a dispute by providing an improved means of tracking all of the disputes a party might be involved in since there is a single location for queries as to the number, type, or status of all disputes involving a party. Beyond the parties to a dispute, this provides a tool for consumer protection or oversight by a regulatory agency or other body concerned with the effectiveness of, and customer satisfaction with, the dispute resolution process.

Further, the centralized, standardized and commonly accessible system provides an improved user experience, as it enables use of a standardized set of user interfaces and procedures that result in easier participation in the DR process, a faster learning curve for users, and more efficient administration of the DR process. Another benefit of the inventive system is that it facilitates use of a single oversight entity for the entire DR system. This single entity can be responsible for the internal management and administration of the entire DR system, the development of DR processes and procedures, enforcement activities, appeals from DR decisions, administration or implementation of dispute outcomes, etc. The result is a more efficient and effective DR system that provides greater user satisfaction than the current set of multiple, unconnected systems.

In some embodiments of the invention, the inventive method includes receiving a request for dispute resolution services from a first party or a second party to a transaction, where as part of the transaction, the first party utilized a first payment processor network and the second party utilized a second payment processor network, and further, where the first payment processor network is different from the second payment processor network. The inventive method includes collecting data regarding the transaction, storing the collected data in a data storage element accessible by the first party and the second party, applying a set of dispute resolution procedures to arrive at a resolution to the dispute, communicating the resolution to the dispute to the first party and second party, and if needed, enforcing terms related to the resolution to the dispute.

In another embodiment, the present invention is directed to a dispute resolution system for resolving a dispute arising from a commercial transaction, where the system includes a data storage element accessible by a first party to the transaction and by a second party to the transaction, where as part of the transaction, the first party utilized a first payment processor network and the second party utilized a second payment processor network, and further, where the first payment processor network is different from the second payment processor network. The invention further includes a user interface accessible by both the first party and the second party, where the user interface is configured to permit the first party or second party to perform one or more operations that include requesting that dispute resolution services be applied to the transaction, providing data related to the transaction for storage in the data storage element, and receiving a notification of an event in the workflow of the dispute resolution process.

Other objects and advantages of the present invention will be apparent to one of ordinary skill in the art upon review of the detailed description of the present invention and the included figures.

### BRIEF DESCRIPTION OF THE DRAWINGS

FIG. 1 is a diagram illustrating a set of closed, proprietary dispute resolution (DR) systems and associated processes that may be used as part of managing and resolving a dispute arising from a commercial credit or debit card transaction;

FIG. 2 is a diagram illustrating an example architecture of a dispute resolution system and associated processes that may be used as part of managing and resolving a dispute arising from a commercial credit or debit card transaction in accordance with some embodiments of the present invention;

FIG. 3 is a block diagram of the primary functional components of a centralized dispute resolution system that may be used to implement some embodiments of the present invention;

FIG. 4 is a block diagram of a typical computer system that may be used to implement some embodiments of the present invention; and

FIGS. 5(a) and 5(b) are flowcharts illustrating an example work flow for a dispute resolution process conducted in accordance with some embodiments of the present invention.

### DETAILED DESCRIPTION

The present invention is directed to systems, apparatus, and methods for managing disputes that arise as the result of commercial credit or debit card transactions. In accordance with some embodiments of the invention, the use of an open, centralized and standardized dispute resolution system overcomes disadvantages of the present system of multiple, unconnected systems, while providing benefits not found in the absence of such a centralized system.

Although the present invention will be described with reference to example embodiments, it is noted that practice of the invention is not limited to those embodiments. For example, the data store may be a single centralized server or may be a distributed data store comprised of multiple interconnected storage elements. Similarly, although in some embodiments the inventive system will be described with reference to a credit or debit card, it is to be understood that the payment mechanism used by a “cardholder” may be a card, RFID tag, mobile phone, result from entry of identification and authentication data, etc. In addition, although certain elements of the inventive system may be depicted as residing in a server or servers, or connected by means of a network or networks, such elements may be separate from one another, or combined, and connected as desired to implement the functions and processes of the invention.

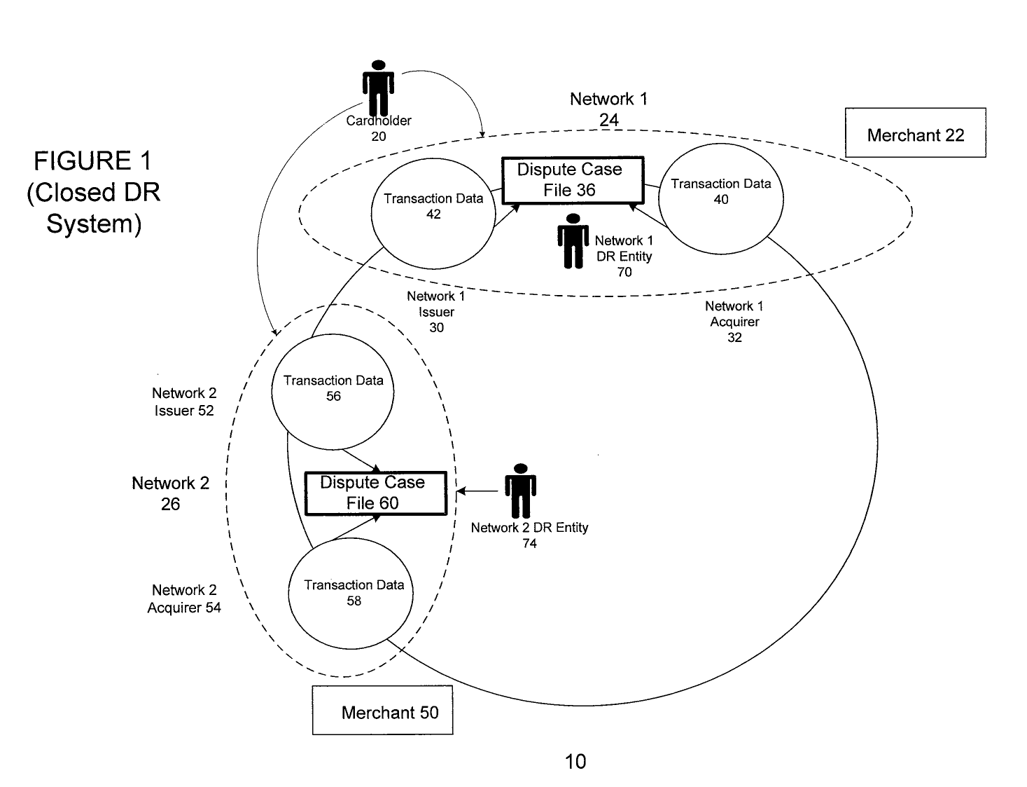

FIG. 1 is a diagram illustrating a set of closed, proprietary dispute resolution (DR) systems and associated processes that may be used as part of managing and resolving a dispute arising from a commercial credit or debit card transaction. As shown in the figure, the overall system 10 is composed of multiple, separate, unconnected DR systems associated with different payment processing or transaction fulfillment networks (e.g., those labeled “Network 1” and “Network 2” in the figure), where in the context of the present invention such separate systems do not share data and may each have their own proprietary procedures and processes. A first network may comprise any suitable combination of computational apparatuses and communication lines and may be operated by a first payment processor (e.g., Visa™). A second network may also comprise any suitable combination of computational apparatuses and communication lines but be operated by a second payment processor (e.g., Paypal™ or Mastercard™). The first and second networks may have some elements in comment, but they differ in that they do not share the exact same combination of computational apparatuses and communication lines. Further, each “network” requires that users of the payment mechanism or payment processor associated with that network utilize the DR system associated with that network.

Typically, for each such system there is a separate and potentially duplicative set of elements and processes, including, but not limited to data stores, user interfaces, activity codes, rules, processes, procedures, etc. In such a DR environment, each system or network is “walled off” from the others and the participants in a DR process must belong to and utilize the same system and procedures. For example, if a transaction involved a Visa™ card as the payment mechanism, then the DR system used to resolve a dispute arising from that transaction would be restricted to that utilized by Visa™ network members (meaning that the merchant and acquirer would also be required to be members of that network).

In a typical situation that might lead to a dispute, a cardholder 20 engages in a transaction with a merchant 22. The transaction may be a purchase of a good or service using a credit card, debit card, or other payment mechanism, where the card issuer 30 and merchant acquirer 32 are members of a common network or group (for example, Network 1, element 24 in the figure). If the cardholder is dissatisfied with some aspect of the transaction and initiates a dispute, then the cardholder must utilize the DR system corresponding to the card issuer or payment processor network involved (in this case, Network 1). Thus, if the transaction was conducted using a Visa™ card, the cardholder must utilize the DR system associated with Visa™ or with the issuer of the Visa™ card. Similarly, if the transaction was conducted using a MasterCard™, then the cardholder must utilize the DR system associated with MasterCard™ or with the issuer of the MasterCard™, which may have different rules, regulations or procedures than the DR system for the Visa™ card.

The cardholder or merchant will typically initiate a dispute by contacting an assigned dispute resolution system representative, customer care representative or other entity 70 having information about and/or administrative or management responsibility for the dispute resolution process. The DR system may be a service operated by the card issuer, payment processor, or an intermediary representing an organization of card issuers, for example. After initiation of a dispute, the DR system may create a dispute case file 36 for the dispute, where the file represents a data depository for information concerning the dispute process, the transaction that caused the dispute, and the parties to the dispute, among other data. Note that dispute case file 36 may contain transaction related data (elements 40 and 42) provided by either or both parties to the transaction (i.e., cardholder 20 and merchant 22). The DR system may also perform certain data processing tasks, such as assigning an identification number to the dispute and storing all data regarding the dispute in a common data store. The DR system may also determine what information is lacking that will be needed for the DR process, and generate requests for that data to the relevant party or parties to the dispute. The DR system may send such requests for information to other of the parties involved in the dispute, such as the card issuer or merchant, or query a database for transaction data, user account data, etc. An exemplary description of the type(s) of data that may be utilized in a DR system and the parties involved in a dispute that may have access to that data is described in U.S. patent application Ser. No. 10/172,762, entitled “Method and System for Facilitating Electronic Dispute Resolution”, filed Jun. 13, 2002, the contents of which is hereby incorporated by reference in its entirety.

As shown in the figure, in the case of a different transaction (e.g., between cardholder 20 and merchant 50), a different dispute resolution system may be required to be used. For example, if the payment mechanism used by cardholder 20 in the transaction with merchant 50 is part of a different network than that for the transaction with merchant 22, then the DR system corresponding to that network (labeled “Network 2”, element 26 in the figure) would have to be used. Similarly, if merchant 50 is not part of Network 1, then disputes arising out of transactions with merchant 50 may have to be resolved using the DR system of Network 2. Note that in this example, because Network 2 issuer 52 and Network 2 acquirer 54 belong to Network 2, the DR system data store, processes, procedures, rules, etc., are not accessible by members of Network 1 for purposes of resolving a dispute arising out of a transaction between cardholder 20 and merchant 50.

Similarly to the dispute resolution activity described with reference to Network 1, the DR system associated with Network 2 may also use a dispute case file 60 as a data store for information related to the disputed transaction (elements 56 and 58 in the figure), where that information may be provided by Network 2 issuer 52 and/or Network 2 acquirer 54. Further, as described with reference to the transaction between cardholder 20 and merchant 22, in the case of a dispute arising out of a transaction between cardholder 20 and merchant 50, the DR system may be administered or managed by a Network DR Entity 74.

As described with reference to FIG. 1, each card issuer or network of issuers, or acquirer or network of acquirers typically have their own DR system. This means that the DR system utilized by a cardholder, merchant, or other party to a dispute must be the one corresponding to the payment processor, card issuer network, etc. that is responsible for the transaction or transaction processing. In this sense, the parties to a dispute must belong to a common network, group or other form of affiliation in order to utilize a specific DR system (e.g., a common payment mechanism group, payment processor group, transaction fulfillment group, etc.). In other words, the common network, group or other form of affiliation to which the parties to a transaction belong determines (and in effect limits) the DR system they may utilize. Thus, depending upon the payment processor, card issuer or acquirer network involved, a card holder or merchant may have to use multiple DR systems in order to handle disputes arising during the course of business.

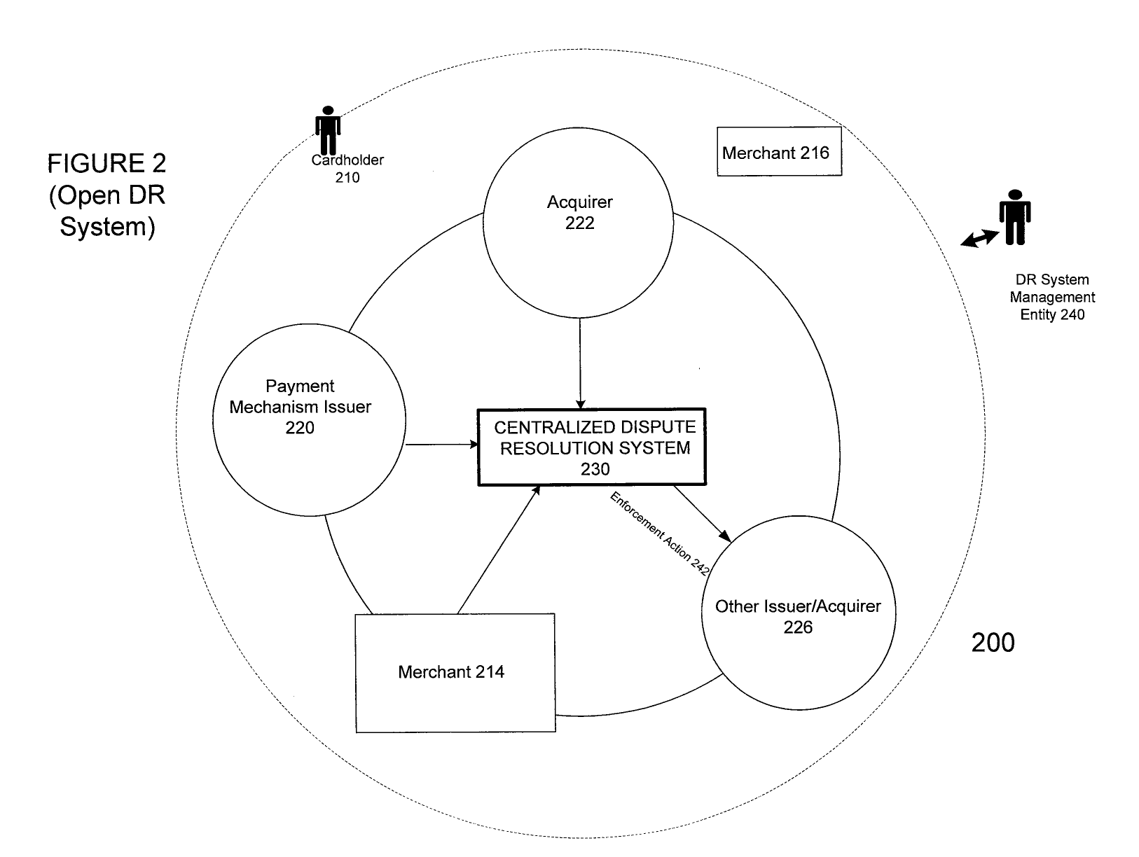

FIG. 2 is a diagram illustrating an example architecture 200 of a dispute resolution system and associated processes that may be used as part of managing and resolving a dispute arising from a commercial credit or debit card transaction, in accordance with some embodiments of the present invention. As shown in the figure, in some embodiments of the inventive system, the parties to a dispute, for example cardholder 210 and merchant 214, have access to and utilize a common dispute resolution system 230, regardless of the payment processor, issuer or acquirer network, transaction intermediary, etc. that each utilized as part of the transaction. Thus, in accordance with some embodiments of the present invention, the network or group to which a card issuer, merchant, payment processor or other party to a dispute belongs or is affiliated with does not restrict their access to data residing within other networks, as that data pertains to the transaction of interest. In addition, the parties are not required to utilize the DR processes and procedures specific to a particular network or group. For example, Payment Mechanism Issuer 220 and Acquirer 222 may not belong to the same network or group, and yet a dispute involving those parties may still be resolved using the inventive system 230. Similarly, regardless of any network or group affiliation, a dispute arising from a transaction involving merchant 216 or Other Issuer/Acquirer 226 may be resolved using system 230. All parties to a dispute may access dispute related data regardless of the issuer or acquirer network to which they belong. Further, all parties utilize a common set of processes, interfaces, rules, identifying codes, regulations, etc., so that not only is the administrative overhead reduced, but greater satisfaction for participants may be obtained because of a reduced learning curve and standardized and well-understood systems and methods.

As an example, FIG. 2 shows use of the inventive DR system for a transaction involving a cardholder 210, merchant 214, card issuer 220, and acquirer 222, where the issuer 220 and acquirer 222 belong to different networks (meaning, for example, that they are not required to be part of the same network for purposes of utilizing the DR system, or that the transaction that gave rise to the dispute need not have been between members of the same network). Note that in the context of the present invention, a “network” as used herein refers to a common group or association of issuers or acquirers with regards to the transaction, where that group utilizes a set of systems, apparatus, communication lines, etc. that are not accessible by members of a different group or association. Note further that the inventive system may also be used by parties belonging to a common group, network or affiliation, but that such a relationship is not required.

As an example, and with regards to the transaction in question, the card issuer may belong to the Visa™ network, while the acquirer may belong to a different network, such as MasterCard™. Using the inventive system, the issuer and acquirer can access the dispute related data at a common storage location, such as a server connected to a communications network, for example the Internet. In some embodiments, the dispute related data may be stored in a data storage element that is accessed on-line using a browser or other application executing on a data processing or computing device. The parties to a dispute or who have data relevant to the dispute may access the data storage element and provide data, comments, analysis, recommendations, etc. in a format that is easily accessible and utilized by all of the parties. One example of such a format is a collaborative workspace, such as that termed a “Wiki”, which may be understood as a website that encourages collaborative document production or task completion by allowing visitors to add, remove, and otherwise edit and manage content.

In one embodiment, the DR system 200 may be administered by a DR system management entity 240, where such entity is responsible for the maintenance of the DR system and for the management of the DR process, including the rules, regulations, procedures, standards, data formats, activity codes, etc. that are part of, or utilized with, the DR system. The DR system management entity 240 may be responsible for ensuring compliance with the agreed-upon rules and procedures, the enforcement of penalties, the final adjudication of disputes or aspects of a dispute, and other functions agreed to by the participants. The DR system management entity 240 may be a member of one of the networks participating in the DR system, or preferably, an independent and neutral third party.

The DR system management entity 240 may provide not only administrative, policing, and adjudication functions, but also may serve as the primary point of contact for all parties to a dispute. In this role, the DR system management entity 240 may be the party contacted to initiate a dispute, and in that role act to manage the dispute resolution process, including the retrieval of data relevant to the dispute, notification of parties involved in the dispute as to the progress of the DR process, and implementation of any enforcement actions required as a result of the adjudication of the dispute (as indicated by the element labeled “Enforcement Action 242” in the figure).

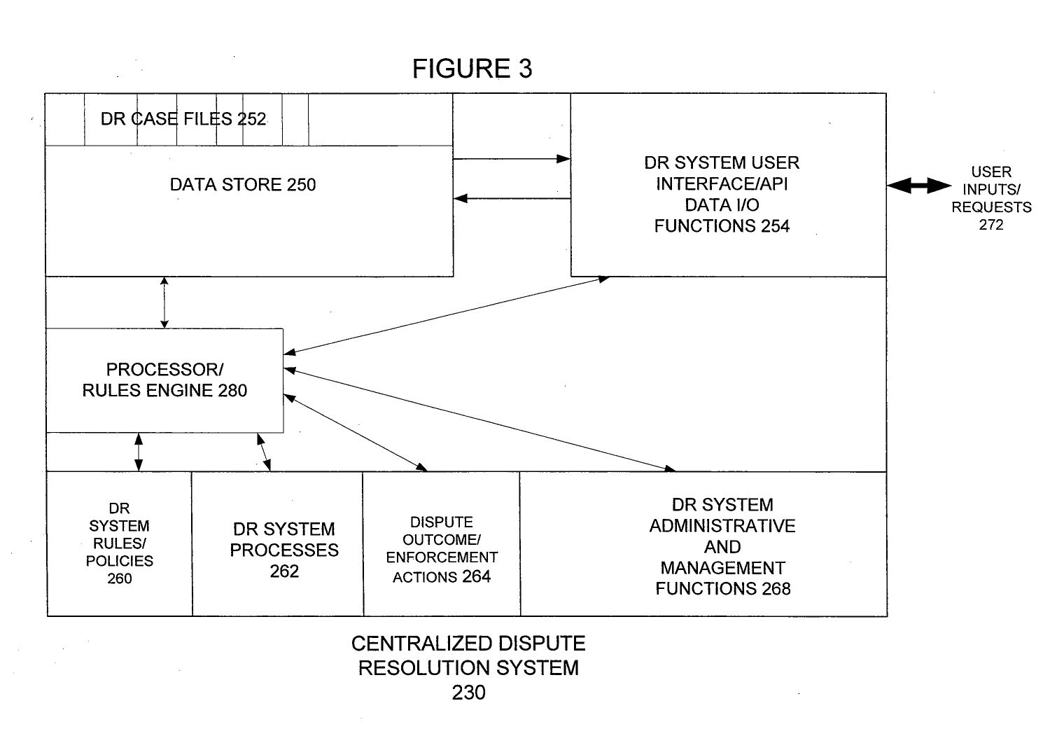

FIG. 3 is a block diagram of the primary functional components of a centralized dispute resolution system 230 that may be used to implement some embodiments of the present invention. As will be described in greater detail, DR system 230 includes components that enable interaction with users, storage of transaction and dispute related data, and the application of dispute resolution policies, rules, and processes to the data. The users of DR system 230 include the participants to the transaction that generated the dispute, as well as other parties that may have information relevant to the dispute. These users may provide inputs to the system, requests for information or status updates, or other inputs 272 through a DR system user interface or API (application programming interface) 254. This component of system 230 is primarily responsible for data input and output functions, and may generate a user interface for users or provide an API through which users can connect to the system over a network. Processor 280 executes a set of instructions that implement some or all of the functions of system 230, and may also take the form of a rules engine, state machine or similar element. Data store 250 is used to store data related to the operation of the system, including transaction or dispute process related data. Some or all of the transaction or dispute process related data may be stored in one or more DR case files 252 that are created for initiated disputes.

Dispute resolution system 230 further includes a set of defined rules and/or policies 260 that are applied to the data relevant to a dispute or transaction by processor 280. These rules and/or policies 260 are applied in conjunction with specified DR system processes 262 to evaluate a dispute and determine the outcome of a dispute, or at least attempt to suggest possible ways of resolving the dispute. Given an outcome of a dispute that results from following the dispute system processes and application of the rules and/or policies, the system may apply various enforcement actions 264 in order to bring closure to the dispute. These enforcement actions may include, but are not limited to, collection of a refund, fees or penalty, taking action to bar one or more parties from participation in certain elements of the commercial transaction system, or other suitable action. The system 230 also includes an element that performs administrative and management functions 268, where such functions include evaluation and implementation of system processes, rules, and policies, control of the dispute resolution workflow and related processes, and implementation of enforcement actions, among other functions. Note that the functions described with reference to FIG. 3 may be provided as part of a web service, a collaborative workspace, a client-server architecture, etc.

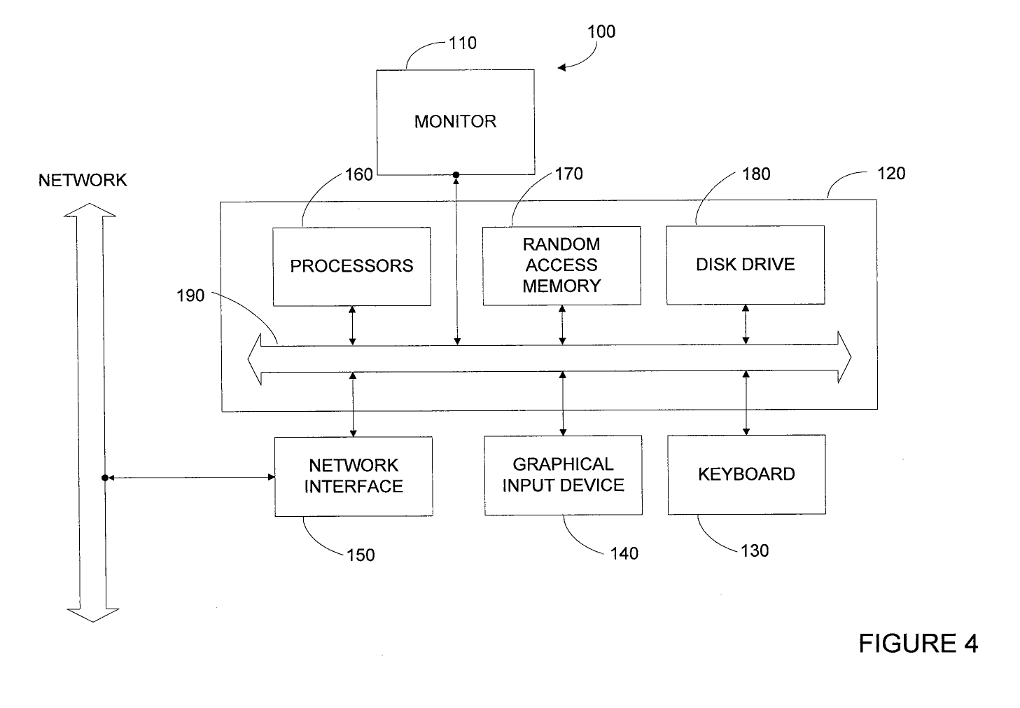

FIG. 4 is a block diagram of a typical computer system 100 that may be used to implement some embodiments of the present invention. The elements shown in FIG. 4 may be implemented as part of the client side device that permits a user to communicate with the DR system, and/or as part of the DR system itself. In one embodiment, computer system 100 typically includes a monitor 110, computer 120, a keyboard 130, a user input device 140, computer interfaces 150, and the like. Note that some of the elements to be described with reference to FIG. 4 may be implemented as part of the system described with reference to FIG. 3, or may be implemented in addition to that system.

In one embodiment, user input device 140 is typically embodied as a computer mouse, a trackball, a track pad, a joystick, wireless remote, drawing tablet, voice command system, eye tracking system, and the like. User input device 140 typically allows a user to select objects, icons, text and the like that appear on the monitor 110 via a command such as a click of a button or the like.

Embodiments of computer interfaces 150 typically include an Ethernet card, a modem (telephone, satellite, cable, ISDN), (asynchronous) digital subscriber line (DSL) unit, FireWire interface, USB interface, and the like. For example, computer interfaces 150 may be coupled to a computer network, to a FireWire bus, or the like. In other embodiments, computer interfaces 150 may be physically integrated on the motherboard of computer 120, may be a software program, such as soft DSL, or the like.

In various embodiments, computer 120 typically includes familiar computer components such as a processor 160, and memory storage devices, such as a random access memory (RAM) 170, disk drives 180, and system bus 190 interconnecting the above components. In one embodiment, computer 120 includes one or more Xeon microprocessors from Intel. Further, in one embodiment, computer 120 typically includes a UNIX-based operating system.

RAM 170 and disk drive 180 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In some embodiments, computer system 100 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 4 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Xeon™, Pentium™ or Core™ microprocessors; Turion™ 64, Opteron™ or AthIonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board (e.g. graphics processor unit).

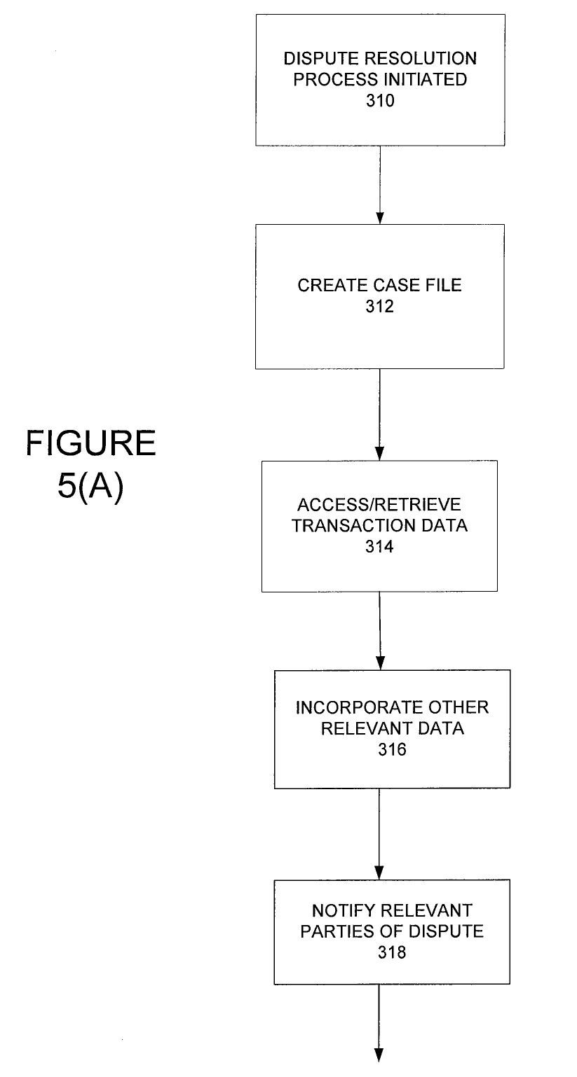

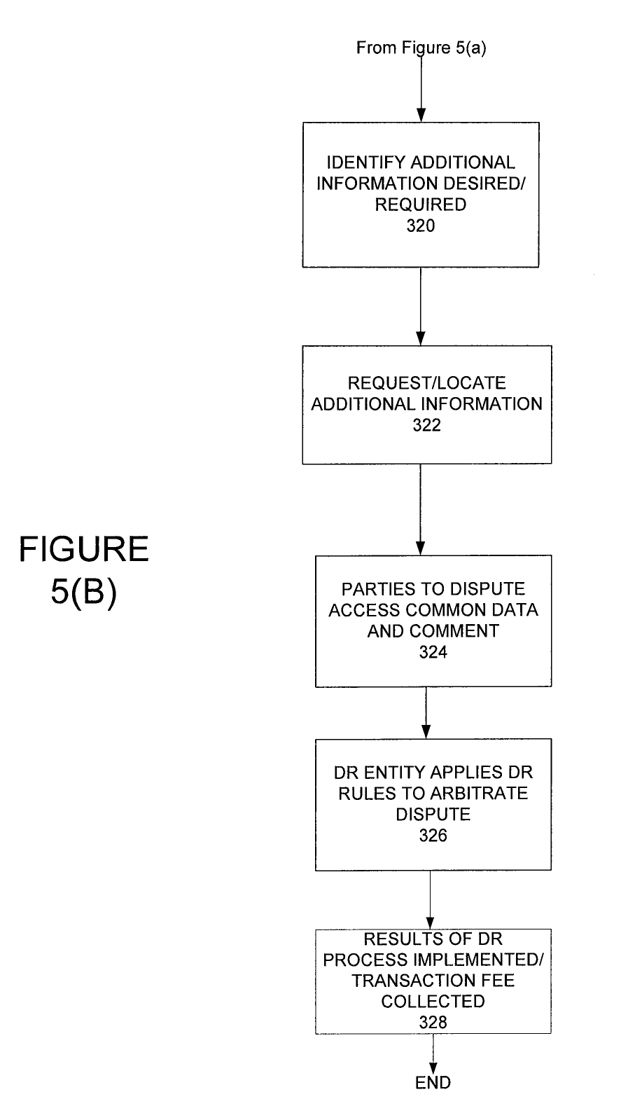

FIGS. 5(a) and 5(b) are flowcharts illustrating an example work flow for a dispute resolution process conducted in accordance with some embodiments of the present invention. Note that although the process described with reference to the figures represents one set of steps or stages that may be implemented as part of an embodiment of the present invention, the steps or stages may be executed in a different order, include other steps or stages, or lack certain of the steps or stages, and still fall within the concept of the invention.

As shown in FIG. 5(a), the inventive dispute resolution system is typically utilized by a card holder, card issuer, merchant or other party by first initiating the dispute resolution process (stage 310). This may involve contacting a representative of the DR system management entity or other party via a messaging system (email, SMS, or IM for example), interactive voice response system (IVR), activation of a link on a web-page, submission of a form using a web-site, or other suitable method. Based upon the contractual relationship between the users of the DR system, the action of initiating the DR process may be recognized as a formal request for the DR management entity to undertake resolution and/or arbitration of the dispute in accordance with procedures and rules agreed to by the participants. These rules may be agreed upon in advance, via agreement at the time of initiating the request or by another similar method. In addition to agreeing to be bound by the DR system rules, processes, and regulations, the participants may also be required to abide by the outcome of the DR process with no appeal available, or with only limited avenues for appeal.

Upon receipt of notice of the initiation of a request for the services of the DR system, the system will typically create a case file (stage 312) representing a data storage location or data structure (e.g., database file, Wiki or other data depository for use in generating a collaborative workspace, etc.) for data relevant to the DR process. The case file will typically be accessible to the participants in the dispute via a communications network, such as the Internet. The participants may access the case file using an application executing on their computing device, a browser, or other similar method. The participants may access the case file using a desktop computing device, laptop computer, mobile device (such as PDA or mobile phone), IVR system, or other suitable method. Note that the case file or other data structure may provide unregulated access to the data contained within it to all participants, or more likely, will be implemented in conjunction with an access control policy in which certain participants have limited or no access to certain information. The data contained in the case file may be password protected, encrypted or otherwise protected from disclosure to unauthorized parties.

After creation of the case file, the DR system will typically search for or otherwise access the relevant data concerning the transaction that led to the dispute (or for transaction data not already supplied by the party initiating the DR process). The transaction data may be stored within the DR system or as part of the data processing operations of one of the participants in the transaction. As noted, it may also be provided by one of the parties to the transaction either as part of initiating the DR system processes or in response to a request from the DR system. Regardless of how obtained, the transaction data is identified and retrieved (stage 314) for storage in the case file. The transaction data will typically include a record of the parties to the transaction (cardholder and merchant), the date, amount, location, and type of transaction (debit or credit), images of records of the transaction, and some information identifying the good or service involved in the transaction.

If relevant to the dispute, one or more of the parties to the transaction may provide or be requested to provide additional data, apart from that found in the transaction record(s). Such additional data may include, for example, photographs of the condition of an object upon sale, packaging, transport, or receipt if such condition is relevant to the dispute. Other data, such as shipment tracking data or delivery records may also be relevant and could be provided by one or more of the parties to the transaction. Such data, if received by the DR system would also be stored in the case file (stage 316).

If not performed previously, the DR system will then notify the participants in the transaction and/or other relevant parties to the dispute resolution process of the initiation of a dispute (stage 318). Note that depending upon the circumstances of the transaction and reasons for the dispute, certain of the parties involved in the transaction may not be notified, as they will have no further role in the DR process. Note also that in this stage and the previous stages, the participants to the transaction and as well as those involved in the DR process need not be part of the same network or organization, or have a common affiliation. Thus, the data in the case file may be supplied by parties belonging to different payment networks, parties using different payment processors, parties using different card issuer or acquirer networks, etc.

In addition to the parties to the dispute providing data to, and being able to access data from, a common data store regardless of network or other type of affiliation, the parties also participate in a DR process that is governed by a single set of commonly agreed upon processes, procedures, rules, regulations, event codes, user interfaces, etc. As will be discussed further, the combination of a common data store and agreed upon procedures and processes overcomes disadvantages of using multiple independent DR systems, while also providing new and beneficial services and advantages.

Next, at stage 320 (as shown in FIG. 5(b)) the DR system may identify data or information that is required or desired in order to execute the DR process. This data may be related to the transaction, to one of the parties involved directly or indirectly in the transaction, to the product or services involved in the transaction, etc. This information may be identified by the DR system as a result of applying a rule set or heuristic, by comparison of the received data to a list of that required to proceed with the DR process, as the result of review of the received data by a participant to the transaction or human intermediary in the DR process, or other suitable procedure.

After identifying the additional desired or required data, the DR system will notify the party presumed to have access to the data of the system's interest in the data and request that the data be provided to the DR system for storage in the data store (stage 322). The other parties to the dispute as well as any DR management entity and/or arbitrating body may also be notified of the data request as part of the workflow or to enable monitoring of the workflow. This and other of the previously described stages in the DR process (e.g., stage 320) may occur more than once during a DR process as the system continues to identify data or other information pertinent to, desired, or required for resolution of the dispute and implementation of the outcome of the DR process.

At stage 324, the parties involved in the DR process may access the common data store and review the data, comment upon it, ask questions concerning the data or the transaction that resulted in the dispute, etc. To facilitate such interactions the common data store may be linked to, or presented as part of, a collaborative workspace (such as a Wiki or similar construct) to enable the parties to access the data and comments of others involved in the DR process, and maintain a running account of the comments, questions, and opinions of others. Note that in accordance with the access control policy of the DR system, not all parties involved in the DR process may have access to the same data and/or comments provided by others to the collaborative workspace.

After collection of the relevant data, information, comments, evidence, or other inputs of the parties to the DR process, the DR system management entity or dispute arbitrator applies the relevant dispute resolution rules or policies to determine the outcome of the dispute (stage 326). Note that these rules or policies have been agreed to by the parties involved in the DR process and may or may not be the same as those previously applied in the separate DR systems used by networks or affiliated parties (as described with reference to FIG. 1).

The outcome of the DR process may be a demand for payment of funds to the cardholder or merchant, a finding of the likelihood of a fraudulent action having occurred, the imposition of damages or some form of penalty, or another action. If payment or other form of damages was not appropriate or collectable (as might result from bankruptcy or an unwillingness by the responsible party to make restitution), the DR system management entity could be authorized to block the proper party from having access to the commerce transaction payment system and/or attempt to collect the funds due from another source linked to the DR system (such as a banking institution, an employer via garnishing of wages, insurance company, etc.). In addition to implementing and if needed, possibly enforcing the outcome of the DR process, the DR system management entity may be entitled to collect a transaction fee for mediating or arbitrating the dispute, as well as a portion of the disputed amount (stage 328).

A centralized dispute resolution system for use in resolving disputes arising form commercial credit card or debit card transactions has been described. The transaction may be for goods or services, and may between a cardholder and merchant (or service provider) that belong to (or utilize) different issuer or acquirer networks, different payment processors, and in general lack a common commerce or financial affiliation. The inventive system provides a common data storage for data or information relevant to the transaction that led to the dispute, and a common set of user interfaces, dispute resolution processes, procedures, rules, event codes, policies, etc. to enable all parties to the dispute resolution process to more effectively interact and participate in the process.

As a result of the inventive system, certain disadvantages of previous systems are overcome, and new services and benefits are provided. The new services and benefits include, but are not limited to:

Management of the dispute resolution process regardless of the e payment entities involved (e.g., Visa, Master Card, PayPal);

The ability to identify potentially fraudulent transactions or parties causing disputes regardless of the payment processor by looking at dispute patterns in a global sense over multiple payment or transaction systems;

The ability to bar fraudulent parties from conducting e payment transactions until disputes have been settled in one or across multiple payment or transaction networks;

Permitting merchants and payment originators (e.g. cardholders) to initiate a dispute in one place rather than discretely through a variety of payment institution(s); and

Providing a standardized means of providing, accessing, and exchanging data relevant to the dispute between the parties involved in the transaction and the dispute resolution process.

The inventive DR system provides efficiencies and a reduction in administrative overhead by centralizing the dispute resolution process, so that merchants, cardholders, banks and others involved in the transaction and payment process deal with a single entity capable of mediating and resolving transaction related issues. Further, the centralized system enables cardholders or merchants to check the status of all the disputes they are involved in at a single location, regardless of the payment processor or financial or commerce network involved. In addition, if open payment standards are adopted regardless of the payment processor, a single dispute resolution entity might be a neutral 3rd party able to resolve the dispute impartially between processors. As a result, cardholders and/or merchants that exhibit a pattern of fraudulent activities could be discovered and barred from payment networks even if they used multiple payment processors.

It should be understood that elements or functions of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

The software components or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method of resolving a dispute arising from a commercial transaction, comprising:
receiving a request for dispute resolution services from a first party or a second party to a transaction, wherein as part of the transaction, the first party utilized a first payment processor network and the second party utilized a second payment processor network, and further, wherein the first payment processor network is different from the second payment processor network;
collecting data regarding the transaction;
storing the collected data in a data storage element, wherein the data storage element is accessible by the first party and the second party;
applying a set of dispute resolution procedures to arrive at a resolution to the dispute;
communicating the resolution to the dispute to the first party and second party; and
if needed, enforcing terms related to the resolution.

2. The method of claim 1, wherein the first party is one of a cardholder, a card issuer, or a member of the first payment processor network.

3. The method of claim 1, wherein the second party is one of a merchant, an acquirer, or a member of the second payment processor network.

4. The method of claim 1, wherein the data storage element is an element of a collaborative workspace.

5. The method of claim 4, wherein the collaborative workspace is a Wiki application.

6. The method of claim 1, wherein the dispute resolution services are administered by a dispute resolution entity, and further, wherein the dispute resolution entity is authorized to perform one or more of the following:
enforce a payment collection or a payment refund from either the first party or the second party; and
institute an action to block either the first party or the second party from utilizing certain elements of a set of commercial transaction services.

7. The method of claim 1, further comprising:
collecting data related to a plurality of transactions and parties to those transactions; and
processing the collected data to identify potentially fraudulent transactions or parties to a potentially fraudulent transaction.

8. The method of claim 1, wherein the data stored in the data storage element is accessible over the Internet.

9. The method of claim 1, further comprising:
requesting additional information regarding the transaction or the parties to the transaction from the first party, the second party, or another party relevant to the transaction; and
accepting data or comments relevant to the transaction from the first part, second party or another party and storing them in the data storage element

10. An apparatus for use in resolving a dispute arising from a commercial transaction, comprising:
a processor;
a data storage element configured to store a set of instructions executable by the processor, wherein when executed, the instructions implement a process to
receive a request for dispute resolution services from a first party or a second party to a transaction, wherein as part of the transaction, the first party utilized a first payment processor network and the second party utilized a second payment processor network, and further, wherein the first payment processor network is different from the second payment processor network;
collect data regarding the transaction;
store the collected data in a data storage element, wherein the data storage element is accessible by the first party and the second party;
apply a set of dispute resolution procedures to arrive at a resolution to the dispute;
communicate the resolution to the dispute to the first party and second party; and
if needed, enforce terms related to the resolution to the dispute.

11. The method of claim 10, wherein the first party is one of a cardholder, a card issuer, or a member of the first payment processor network.

12. The method of claim 10, wherein the second party is one of a merchant, an acquirer, or a member of the second payment processor network.

13. The apparatus of claim 10, wherein the data storage element is an element of a collaborative workspace.

14. The apparatus of claim 13, wherein the collaborative workspace is a Wiki application.

15. The apparatus of claim 10, wherein the instructions further implement a process to
collect data related to a plurality of transactions and parties to those transactions; and
process the collected data to identify potentially fraudulent transactions or parties to a potentially fraudulent transaction.

16. A dispute resolution system for resolving a dispute arising from a commercial transaction, comprising:
a data storage element accessible by a first party to the transaction and by a second party to the transaction, wherein as part of the transaction, the first party utilized a first payment processor network and the second party utilized a second payment processor network, and further, wherein the first payment processor network is different from the second payment processor network; and
a user interface accessible by both the first party and the second party, the user interface configured to permit the first party or second party to perform one or more of the following operations
request that dispute resolution services be applied to the transaction;
provide data related to the transaction for storage in the data storage element; and
receive a notification of an event in the workflow of the dispute resolution process.

17. The system of claim 16, wherein the data storage element is accessible over the Internet.

18. The system of claim 16, wherein the data storage element is associated with a collaborative workspace.

19. The system of claim 18, wherein the collaborative workspace is a Wiki application.

20. The system of claim 16, further comprising:
a set of dispute resolution processes; and
a set of dispute resolution rules or polices, wherein the dispute resolution processes and rules or polices are applied to the data stored in the data storage element to determine an outcome of the dispute.

21. A method comprising:
receiving information regarding a first dispute, wherein the first dispute originates from a transaction involving a first payment processing organization;
receiving information regarding a second dispute, wherein the second dispute originates from a transaction involving a second payment processing organization; and
managing resolution of the first and second disputes using a common dispute resolution system.

22. The method of claim 21, wherein the common dispute resolution system comprises
a common set of dispute resolution processes; and
a common set of dispute resolution rules or polices.

23. The method of claim 21, wherein the information regarding the first dispute and the second dispute is stored in a data storage element accessible by the first payment processing organization and by the second payment processing organization.

24. The method of claim 23, wherein the data storage element is accessible over the Internet.

25. The method of claim 24, wherein the data storage element is associated with a collaborative workspace.

26. The method of claim 25, wherein the collaborative workspace is a Wiki application.
